(19) United States
(12) Patent Application Publication
(10) Pub. No.: US 2008/0005252 A1
(43) Pub. Date: Jan. 3, 2008

(54) Searching users in heterogeneous instant messaging services

(76) Inventor: Roberto Della Pasqua, Savignano Sul Rubicone (RN) (IT)

Correspondence Address: Bryan A. Santarelli;GRAYBEAL JACKSON HALEY LLP, Suite 350, 155 - 108th Avenue NE, Bellevue, WA, 98004-5973, US

(21) Appl. No.: 11/810,789

(22) Filed: Jun. 6, 2007

(30) Foreign Application Priority Data
Jun. 6, 2006 (IT) MI2006A001093

(51) Int. Cl. G06F 15/16

(52) U.S. Cl. 709/206

(57) ABSTRACT

An embodiment of a method for searching users in a distributed data processing system is proposed. The system includes a plurality of messaging servers each one for providing a corresponding messaging service and a plurality of clients each one for exploiting at least one of the messaging services. The method includes the steps of: activating each one of a set of users through a corresponding client in a messaging service on the corresponding messaging server, notifying an indication of the activated user to a searching server by the corresponding client or messaging server, adding the activated user to a searching structure indicative of all the users being active in the system, querying the searching server by a further user through a corresponding further client according to a search criterion, selecting the active users in the searching structure that satisfy the search criterion, returning an indication of the selected users from the searching server to the further client, and contacting at least one of the selected users by the further user.

### PRIORITY CLAIM

This application claims priority from Italian patent application No. MI2006A001093 filed on Jun. 6, 2006, the entire disclosure of which is herein incorporated by reference to the maximum extent allowable by law.

### TECHNICAL FIELD

An embodiment of the present invention relates to the information technology field. More specifically, an embodiment of the present invention relates to the searching of users in instant messaging services.

### BACKGROUND

Messaging services (especially of the instant type) have become of common use, particularly thanks to the widespread diffusion of global communication networks like the Internet. These services allow a number of users to exchange messages (for example, short phrases of text) in real time. For this purpose, each user accesses a server computer that provides the messaging service in the Internet from his/her client computer, such as a mobile telephone of the UMTS type. The user can then send to the other users and receive from them (through the server) the desired messages; this allows the users to exchange information in a direct and immediate way.

An intrinsic problem of the messaging services is that the users registered on the server are not always active (on-line); such users are not able to receive the possible messages that are sent to them, and therefore to respond immediately thereto.

In order to mitigate such problem, the known messaging services generally allow verifying whether a specific user is active at the moment. This makes it possible to prevent the useless sending of messages, which cannot receive an immediate response; moreover, in some cases it is possible to select an alternative user capable of providing the desired response.

A drawback of the solution described above is that it often requires repeated queries of the server for searching the suitable user; such operation may be very annoying and time expensive. Moreover, very often the proposed solution is not feasible, since the alternative users, to which it would be possible to send the same message, are not known a priori.

In some cases, it should be noted that the server also collects personal information of the different registered users to facilitate the exploitation of the messaging service. This information might then be used to search the active user adapted to receive the desired message. However, this may require downloading the information relating to all the active users on the client.

Therefore, many of the solutions known in the art involve an increase of the workload of the server, and a remarkable increment of traffic in the communication network (used to implement the messaging service). Such drawbacks degrade the performance of the messaging service (and also of any other services that are implemented on the same server); moreover, this may bring about a congestion of the entire communication network (with negative side-effects on any other computer connected thereto).

In any case, whatever server typically can only provide information relating to the users that are registered on it. Therefore, no solution exists capable of verifying which users are active at the moment in the messaging services implemented by the other servers; all the more so, it is often not possible in any way to select users that are registered on different servers for sending specific messages. The problem may be particularly acute in modern open environments, wherein a myriad of heterogeneous messaging services are available (based on completely different structures).

### SUMMARY

In its general terms, the present disclosure is based on the idea of allowing the search of active users in different messaging services.

More specifically, an embodiment of the invention provides a method for searching users in a distributed data processing system. The system includes a plurality of messaging servers (each one for providing a corresponding messaging service) and a plurality of clients (each one for exploiting at least one of the messaging services). The method starts with the step of activating each one of a set of users through a corresponding client in a messaging service on the corresponding messaging server. An indication of the activated user is notified to a searching server (by the corresponding client or messaging server). The activated user is added to a searching structure, which is indicative of all the users being active in the system. The method continues with the step of querying the searching server by a further user (through a corresponding further client) according to a search criterion. The active users in the searching structure that satisfy the search criterion are selected. An indication of the selected users is then returned from the searching server to the further client. In this way, it is possible to contact at least one of the selected users by the further user.

Another embodiment of the invention proposes a computer program for performing the method.

A further embodiment of the invention proposes a correspondent system.

### BRIEF DESCRIPTION OF THE DRAWINGS

One or more embodiments of the invention itself, as well as features and the advantages thereof, will be best understood with reference to the following detailed description, given purely by way of a non-restrictive indication, to be read in conjunction with the accompanying drawings, in which:

FIG. 1 is a schematic block diagram of a data processing system in which the solution according to an embodiment of the invention is applicable;

FIGS. 2a-2e show exemplary applications of the solution according to different embodiments of the invention;

FIG. 3 illustrates a generic computer of the above-mentioned system in a schematic way; and

FIG. 4 is a collaboration diagram that represents the roles of the different components that implement the solution according to an embodiment of the invention.

### DETAILED DESCRIPTION

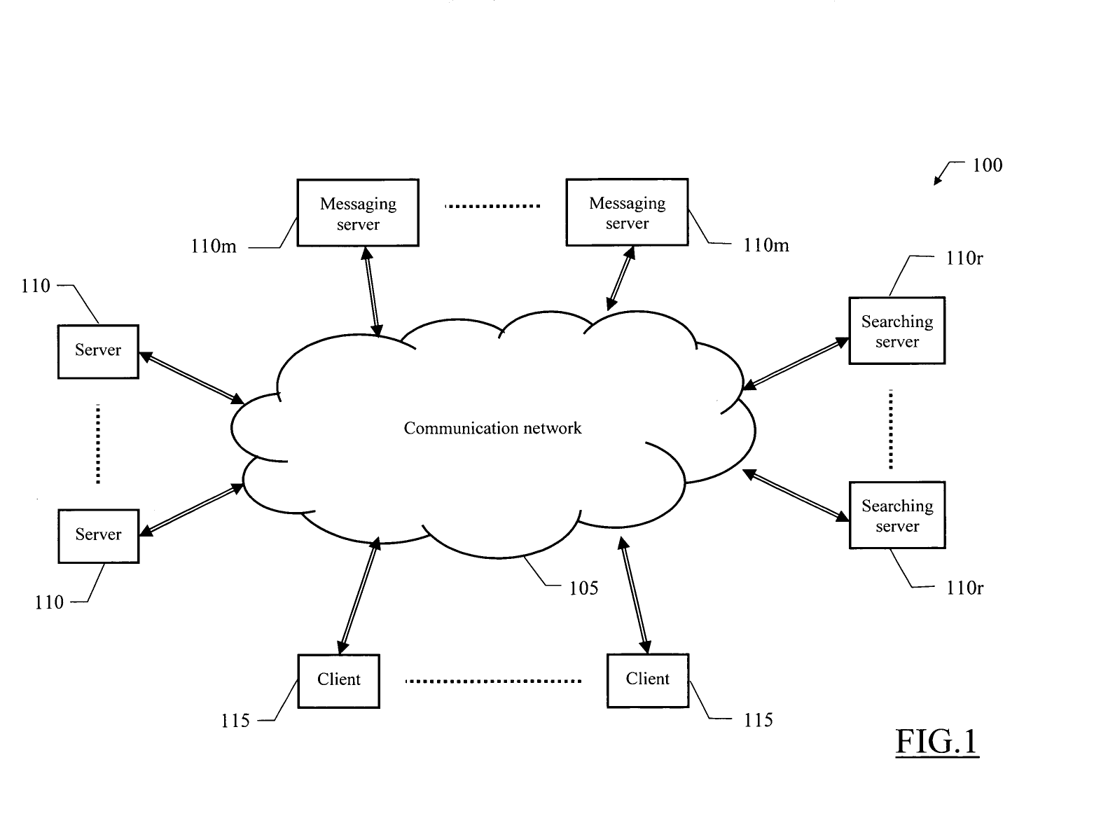

With reference in particular to FIG. 1, there is shown a data processing system 100 with a distributed architecture, typically based on the Internet; the Internet is formed by million of servers, which are connected to each other through a global communication network 105.

A subset of the servers (denoted with 110), known as World Wide Web or simply web, allows accessing corresponding web sites. Each web site consists of a collection of web pages available on the corresponding (web) server 110; the web pages are logically linked to each other, and they can be accessed through a home page. Each web page consists of a hypertext document (formatted in the HTML language), which document is accessed through the HTTP protocol; for this purpose, the web page is identified and localized by means of a correspondent URL (Uniform Resource Locator), which consists of a string formatted according to a standard syntax. The web sites specialize in a multitude of contents or applications; for example, there exist information sites, database access sites, commercial sites, game sites, electronic content downloading sites, portals (providing a central access point to other sites), wiki sites (whose content is defined in a collaborative way), blog sites (used to store discussions), and so on.

Particularly, some servers (denoted with 110m) provide corresponding instant messaging services. More in detail, each messaging server 110m manages real-time chats among different users, thereby allowing them to exchange (that is, to send and receive) instant messages, generally formed by short text phrases.

Other servers (denoted with 110r) are instead used to search the available web sites. The searching servers 110r select the web sites that satisfy particular search criteria (typically defined by keywords, for example, combined with logical operators); moreover, the results are generally ordered according to predefined relevance criteria. As described in detail in the following, in an embodiment of the present invention the searching servers 110r are also capable of searching the active users in the different messaging services (managed by the corresponding messaging servers 110m).

Client computers 115 access the Internet (through computers that operate as access providers, not shown in the figure), in order to exploit the services offered by the different servers 110. Particularly, the users of the clients 115 can access the messaging services provided by the different messaging servers 110m; moreover, the users of the clients 115 can query the searching servers 110r for specific web sites and/or active users in the messaging services.

More in detail, each searching server 110r collects information relating to all the active users in the different messaging services of the whole system 100; for each active user in a specific messaging service, this information is provided to the searching server 110r from the client 115 of the active user or from the messaging server 110m that implements the service. In any case, the active user is defined by an identifier of the messaging server 110m and an identifier being exploited by the user for accessing the messaging service on the same server 110m; it should be noted that the server identifier is unique in the whole system 100, while the user identifier is unique on each messaging server 110m (with the same user identifier that may be used on different messaging servers 110m). The active user is also associated with a correspondent profile, which is defined by one or more search parameters. In such way, another (requesting) user can query the searching server 110r (through the corresponding client 115) by using a desired search criterion. In response thereto, the searching server 110r selects the active users whose profiles satisfy the search criterion. The server/user identifiers of the selected users are returned to the client 115 of the requesting user, which can then contact them in order to exchange messages (through the messaging server 110m on which each selected user is active).

An embodiment of the proposed solution allows selecting the active users in different messaging services; such result is achieved with a simple query, in a very comfortable and fast way. Moreover, this allows choosing the users suitable for a particular purpose (and available at the moment) without the need of knowing any information a priori about them.

The above-described method reduces the workload of the messaging server 110m, with a remarkable reduction of traffic in the communication network 115. Such advantages have a beneficial effect on the performance of the messaging services (and also of any other services implemented on the different servers 110); moreover, this reduces the risk of congestion of the whole communication network 115 (with positive side-effects on the entire system 100).

It should be noted that the devised solution allows selecting the active users on whatever messaging service (and therefore it is not limited to a single messaging server 110m). Such advantage is particularly evident in the modern open environments (in which a myriad of heterogeneous messaging services is available based on structures that are completely different from each other).

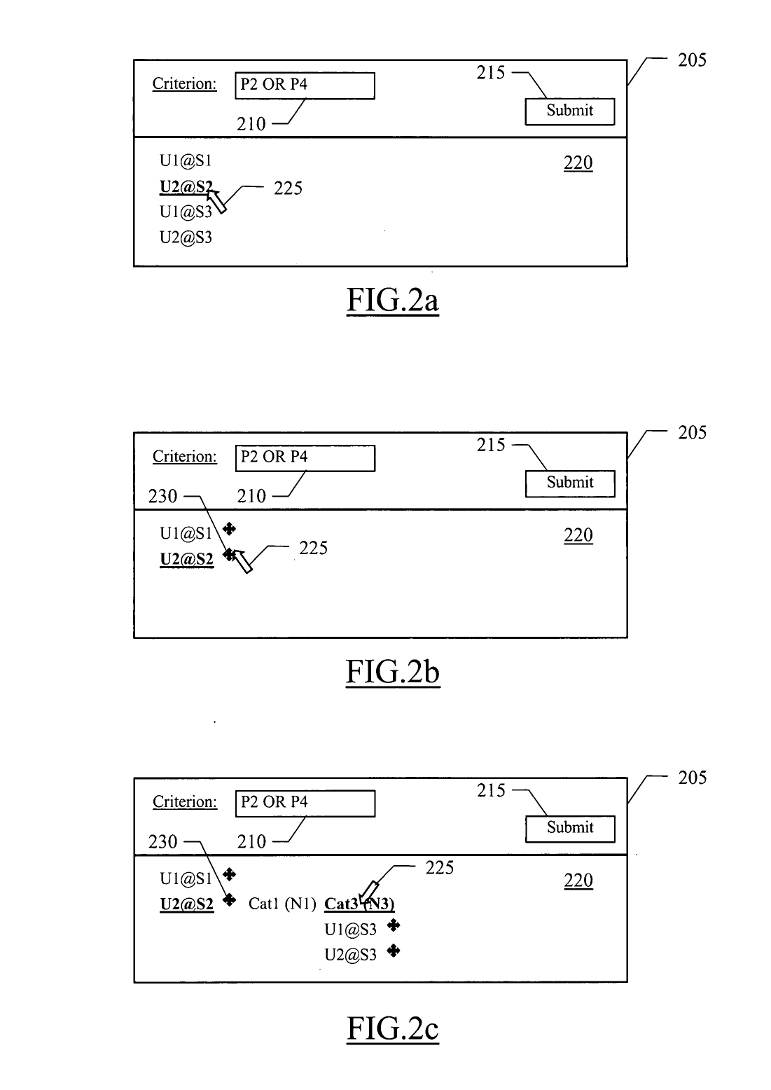

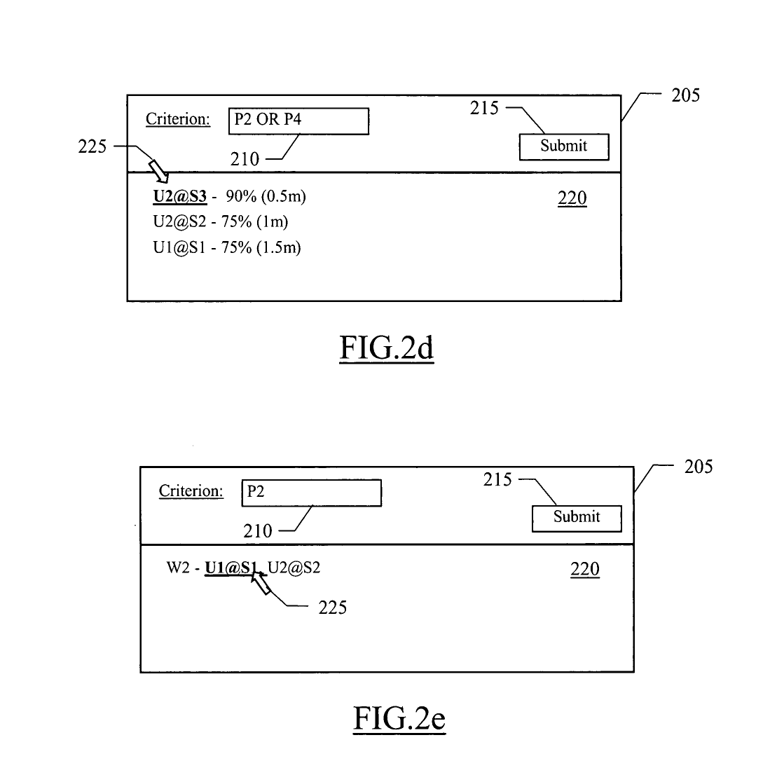

Passing now to FIG. 2a, let us consider a situation in which the following users are active at the moment in three different messaging services (managed by corresponding messaging servers). Each active user is identified by an i-th user identifier Ui for a j-th server identifier Sj (in the form Ui@Sj); the active user Ui@Sj is associated with a profile Kij, which is formed by one or more k-th search parameters Pk:
U1@S1−K11=P1, P2
U2@S1−K21=P3
U3@S1−K31=P1, P3
U1@S2−K12=P1
U2@S2−K22=P2, P3
U1@S3−K13=P4
U2@S3−K23=P1, P4.

As shown in the figure, when the requesting user connects to the searching server, a web page 205 including an input box 210 is displayed on his/her client. The requesting user is then prompted to enter a search criterion in the input box 210, for example:

P2 OR P4.

As soon as the request is submitted to the searching server by clicking on a correspondent button 215, the active users who satisfy such search criterion are selected; in the case in issue, the active users who include the parameter P2 or the parameter in P4 in their profiles Kij are U1@S1, U2@S2, U1@S3 and U2@S3. The searching server returns the result of the search to the client of the requesting user, which displays the user/server identifiers of the selected users in a suitable frame 220 of the web page 205.

The requesting user can then choose anyone of the selected users, for example, the active user U2 on the messaging server S2 (by simply moving a pointer 225 and then clicking on his/her user/server identifier U2@S2). In such way, the requesting user is directly put in contact with the desired user U2 through the respective messaging server S2 (for the purpose of establishing a possible exchange of messages).

Generally, the search parameters Pk of each profile Kij represent characteristics of the corresponding user; typical search parameters Pk are the job of the user (with possible qualifications), the geographic area of activity, and the like. This allows the requesting user to select the active users who exhibit specific characteristics; for example, it is possible to search the users being active at the moment who work as plumbers in a desired city (which can then be contacted immediately to verify their availability).

In addition or in alternative, the search parameters Pk represent characteristics of the client of the user; further typical search parameters Pk are the type of client (such as stationary or mobile), its current position, and the like. This allows the requesting user to select the active users according to dynamic characteristics; for example, it is possible to search the plumbers that are using a mobile telephone (and then are presumably outside their premises), and that are at the moment nearby (so that they might intervene immediately). In this case, the criteria that have concurred to the selection of the active users (such as the distance from the requesting user) can also be displayed, preferably in graphical form, close to the corresponding user/server identifiers to facilitate their choice.

With reference now to FIG. 2b, in a different embodiment of the invention each search parameter Pk is associated with one or more predefined categories in a structure that implements a sort of semantic network; for this purpose, the different categories are correlated to each other according to different association logics (such as per detail level, affinity, and the like).

For example, let us assume that the users selected in response to the previous request are associated with the following m-th categories CATm:
U1@S1: CAT1
U2@S2: CAT2
U1@S3: CAT3
U2@S3: CAT3

In turn, the category CAT1 is correlated with the category CAT2, the category CAT2 is correlated with the categories CAT1 and CAT3, and the category CAT3 is correlated with the category CAT2.

Generally, the frame 220 only displays the user/server identifiers of the most relevant selected users (according to the submitted search criterion); in the example in issue (assuming the selected users in decreasing order of relevance as indicated above), the result shown in the figure is obtained when the frame 220 can only contain two user/server identifiers (that is, U1@S1 and U2@S2). In this case, an expansion button 230 (for example, shaped like a “+”) is displayed close to the user/server identifiers of each selected user. The user can then choose to expand any one of the selected users, for example, the user U2@S2 (as above by moving the pointer 225 and then clicking on the expansion button 230). In such case, the searching server retrieves all the categories correlated with those of the search parameters Pk of the user U2@S2 (that is, CAT1 and CAT3). For each one of such correlated categories, the searching server selects the active users for each correlated category that satisfy the submitted search criterion, and returns the result of the search to the client of the requesting user.

In response thereto, as shown in FIG. 2c, a mnemonic descriptor of each correlated category with the number of the respective selected users is displayed close to the user/server identifier U2@S2 in the frame 220; in the example in issue, the correlated categories are CAT1 and CAT3, for each one of them N1=1 and N3=2 selected users, respectively, are present. At this point, the user can choose any one of the correlated categories, for example, the category CAT3 (again by moving the pointer 225 and then clicking on its descriptor). Consequently, the user/server identifiers of the selected users for the category CAT3 (that is, U1@S3 and U2@S3) are displayed under its descriptor, together with the respective expansion button 230. The process can be reiterated forever until the desired information is obtained.

Such additional feature allows excluding the results that are not relevant for specific purposes. For example, let us assume that the requesting user desires to contact a machine shop for repairing his/her car. In such case, it is possible to submit a request based on a search criterion relating to the brand of the car. As a function of the obtained result, the requesting user identifies several categories correlated with the selected users, and in particular the correlated category of interest (that is, specialized machine shops), in addition to others being not relevant (such as car selling, they repairing, and the like). By selecting the correlated category of the specialized machine shops, it is then possible to obtain the list of the selected users relating to it (thereby limiting the information only to that actually necessary for the purpose at issue).

Passing instead to FIG. 2d, as a further improvement the searching server also determines a responsiveness index of each active user; the responsiveness index consists of a score that indicates how the active user has previously responded to the contact requests (from the different requesting users). For this purpose, the searching server collects the response time to every contact request of the active users in the different messaging services of the whole system; the response is considered missing after a predefined maximum time from the contact request (to example, 2-5 minutes). As above, for each active user in a specific messaging service, such information is supplied to the searching server from the client of the active user or from the messaging server that implements the service. In any case, the responsiveness index of each active user is set to the percentage of responses to the contact requests (for example, based on the responses being returned to the last 50-100 contact requests). In addition or in alternative, the searching server also calculates the average response time (for example, for the responses returned to the same last contact requests).

The responsiveness index is used to arrange the selected users in a preference order. This facilitates the choice by the requesting user of the selected user that is probably more adapted to respond to the contact request.

Moreover, the searching server can also discard the selected users whose responsiveness index does not reach a predefined threshold value (for example, lower than 50%-60% when expressed as percentage of responses and/or higher than 3-4 min. when expressed as average response time). This additional feature avoids the transmission of information relating to selected users, which very likely would not be able to respond to possible contact requests from the requesting user; in such way, the traffic on the communication network is further reduced.

For example, in the case at issue the following percentages of responses and average response times are associated with the active users:
U1@S1−K11=P1, P2−75% (1.5 min.)
U2@S1−K21=P3−60% (1.2 min.)
U3@S1−K31=P1, P3−55% (2 min.)
U1@S2−K12=P1−85% (1 min.)
U2@S2−K22=P2, P3−75% (1 min.)
U1@S3−K13=P4−30% (4.5 min.)
U2@S3−K23=P1, P4−90% (0.5 min.).

Therefore, the active users who satisfy the same search criterion (P2 OR P4) are then arranged in decreasing order of the responsiveness index (for example, for percentage of responses, and average response time for the same percentage of responses):
U2@S3−K11=P1, P2−90% (0.5 min.)
U2@S2−K22=P2, P3−75% (1 min.)
U1@S1−K23=P1, P4−75% (1.5 min.)
U1@S3−K13=P4−30% (4.5 min.).
Moreover, assuming that the threshold value is equal to 50% for the percentage of responses, the user U1@S3 is discarded since his/her responsiveness index (30%) is lower.

Therefore, the searching server returns—to the client of the requesting user—only the information relating to the first three selected users (that is, the respective user/server identifiers with the corresponding responsiveness indexes).

Such information is displayed as above in the frame 220 of the web page 205. In such way, the requesting user can choose the first selected user in the list (as above, by moving the pointer 225 and then clicking on his/her user/server identifier U2@S3). In such way, the requesting user is put directly in contact with the desired user U2 through the respective messaging server S3 (which user U2@S3 is very likely to respond to the contact request in a short time).

In a particular embodiment of the invention, the profile of every active user is defined (completely or in part) through a reference to one or more web sites (for example, for means of the corresponding URLs). In such case, the web sites indicated in the search profile are replaced with the respective search parameters (one or more) being normally used for their indexing by the searching servers.

An embodiment of the proposed solution remarkably facilitates the definition of the profiles of the users. Indeed, the users can simply specify the web sites linked thereto; consequently, the search parameters for identifying these users (as representative of such web sites) are maintained centrally by a manager of the same web sites. This avoids any further intervention of the users, and at the same time it guarantees a uniformity of the profiles of all the users associated with the same web sites (apart from possible additional search parameters relating to characteristics of the users and/or of their clients).

A typical example is that of users working for a specific company; in such case, the users can define their profiles through the web site of the company (so as to guarantee the automatic insertion of all the search parameters associated with the web site over time). In this way, the users (when active in any messaging service) will be selected automatically in response to whatever search criterion relating to their company.

In the embodiment of the invention described above, the searching server can also implement a different querying mode. In particular, the searching server is used as usual to search the web sites (which satisfy a desired search criterion); in addition, the searching server also associates—to each selected web sites—the active users relating thereto (that is, whose profile includes such web site).

For example, let us assume that the profiles of the above-mentioned active users are so defined in terms of a web site W1 (indexed by the search parameter P1) and of another web site W2 (indexed by the search parameter P2):
U1@S1−K11=W1, W2=P1, P2
U2@S1−K21=P3
U3@S1−K31=W1, P3=P1, P3
U1@S2−K12=W1=P1
U2@S2−K22=W2, P3=P2, P3
U1@S3−K13=P4
U2@S3−K23=W1, P4=P1, P4.
As shown in FIG. 2e, the user enters a specific search criterion in the input box 210 (for example, P2) and then submits the request to the searching server (by clicking on the button 215). In response thereto, the searching server selects the web sites that satisfy such search criterion (for example, by using an embedded search algorithm or by exploiting other dedicated searching servers); for the sake of simplicity of description, let us assume that the single selected web site is W2. The searching server also determines the active users who include the web site W2 in the definition of their profiles; in the case in issue, the active users who satisfy such condition are U1@S1 and U2@S2. The searching server returns the result of the search to the client of the requesting user, which displays the received information in the frame 220 of the web page 205. Typically, each selected web site is represented by the corresponding URL with the addition of a short descriptive text; the active users associated with the selected web site are indicated close to it by means of the respective user/server identifiers. In such way, the requesting user (in addition to visit the desired web site W2) can also choose any one of the active users associated therewith, for example, the active user U1 on the messaging server S1 (moving the pointer 225 and then clicking on his/her user/server identifier U1@S1). In such way, the requesting user is put directly in contact with such active user, in order to establish a possible exchange of messages (typically relating to the content of the web site W2).

An embodiment of the proposed solution expands the standard functionalities of the searching server. Particularly, this allows—in a very simple and fast way—not only to access a desired web site, but also to directly enter in contact with corresponding persons. In this way, the interaction with the web sites is made more dynamic. It is also evident that an embodiment of the solution described above offers a number of possibilities for new business approaches.

For example, let us consider the above-mentioned case of users working for a specific company (which users have defined their profiles through the web site of the company). In this way, every search of the web site of the company will return (in addition to its URL) also the user/server identifiers of all the users of the company that are active at the moment in any messaging service. Therefore, the requesting user can contact immediately one of such active users in order to obtain information in real time. For example, such functionality can be exploited to implement a call center; in this case, the users are preferably considered active when available (that is, not already engaged in another conversation).

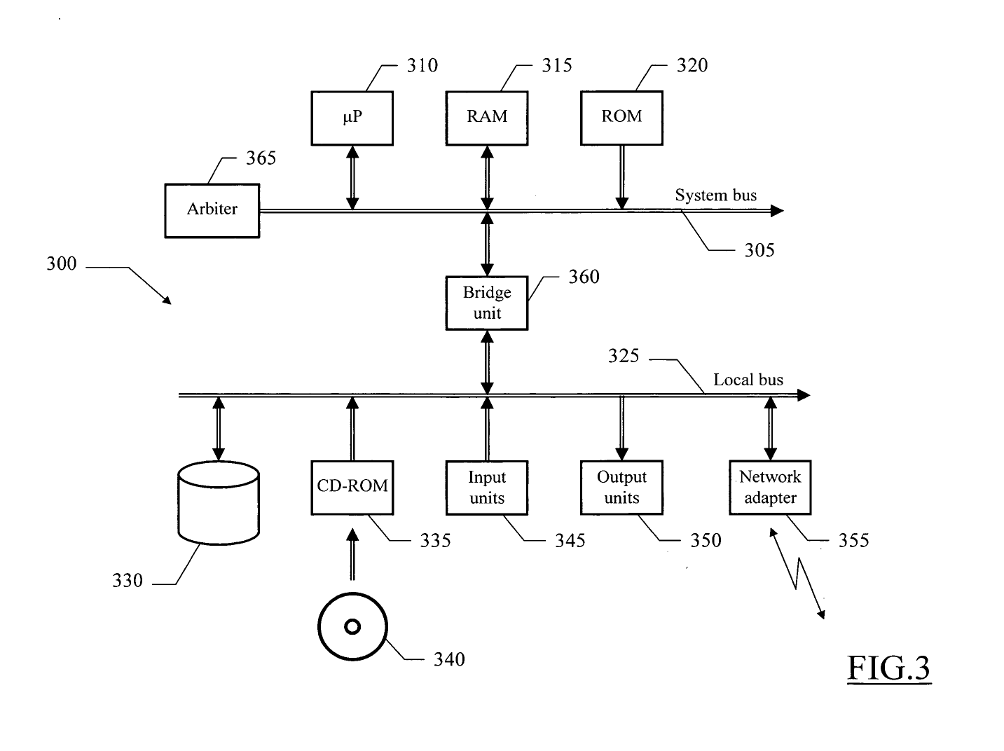

With reference now to FIG. 3, a generic computer of an embodiment of the above-described system is denoted with 300. The computer 300 is formed by several units that are connected in parallel to a system bus 305 (with a structure that is suitably scaled according to the actual function of the computer 300 in the system). In detail, a microprocessor 310 (or more) controls operation of the computer 300; a RAM 315 is directly used as a working memory by the microprocessor 310, and a ROM 320 stores basic code for a bootstrap of the computer 300. Several peripheral units are clustered around a local bus 325 (by means of respective interfaces). Particularly, a mass memory consists of a hard-disk 330 and a drive 335 for reading CD-ROMs 340. Moreover, the computer 300 includes input units 345 (for example, a keyboard and a mouse), and output units 350 (for example, a monitor and a printer). An adapter 355 is used to connect the computer 300 to the communication network. A bridge unit 360 interfaces the system bus 305 with the local bus 325. The microprocessor 310 and the bridge unit 360 can operate as master agents requesting an access to the system bus 305 for transmitting information. An arbiter 365 manages the granting of the access with mutual exclusion to the system bus 305.

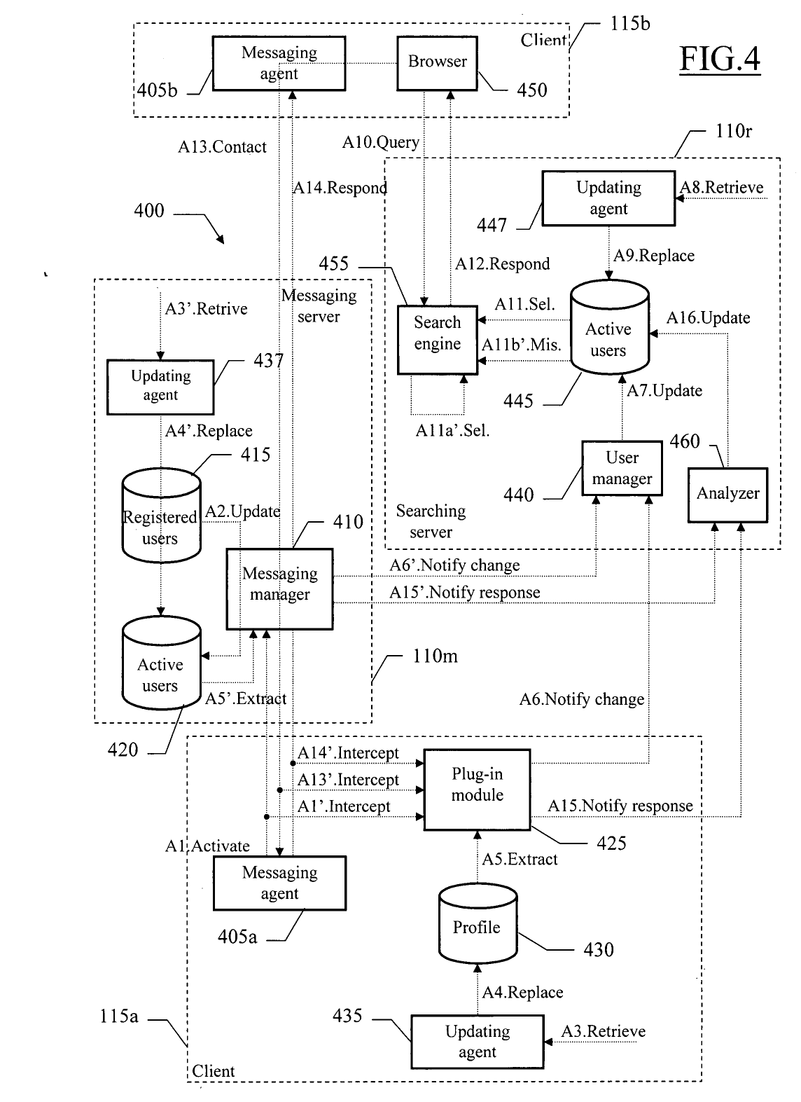

Passing to FIG. 4, the main software components running on an embodiment of the above-described system are denoted as a whole with 400. The information (programs and data) is typically stored on the hard-disk and loaded (at least partially) into the working memory of each computer when the programs are running, in addition to an operating system and other application programs (not shown in the figure). The programs are initially installed onto the hard disk, for example, from CD-ROM. Particularly, the figure describes the static structure of the system (by means of the corresponding components) and its dynamic behavior (by means of a series of exchanged messages, which are denoted with consecutive sequence numbers preceded by the symbol “A”).

In particular, a messaging agent 405a implements a user interface of the messaging service on a specific client (denoted with 115a). Whenever the user of the client 115a wishes to access any messaging service managed by a generic messaging server 110m, the messaging agent 405a accordingly notifies a messaging manager 410 running on the messaging server 110m (action A1). The messaging manager 410 validates the user, by means of his/her user identifier and a respective password that are provided together with the access request; for this purpose, the messaging manager 410 accesses a repository 415, which stores information relating to all the users registered on the messaging server 110m. Assuming that the outcome of the verification is positive, the messaging manager 410 adds the user to a further repository 420 (action A2), which lists all the users that are at the moment active in the messaging service managed by the messaging server 110m.

The request of the user to become active in the messaging service is intercepted on the client 115a by a plug-in module 425, for example, through known hooking techniques (action A1′). The plug-in module 425 interfaces with a table 430, which stores the profile of the user. If the profile 430 includes one or more web sites, an updating agent 435 retrieves the search parameters used for their indexing from the same web sites (action A3). The web sites indicated in the profile 430 are then replaced with the corresponding search parameters (action A4). The plug-in module 425 at this point verifies whether the profile 430 has been modified since a last activation of the user in any messaging service; in the affirmative case, the plug-in module 425 extracts the (new) profile from the table 430 (action A5). The plug-in module 425 then notifies the event to each searching server 110r, only one shown in the figure (action A6). For this purpose, the plug-in module 425 sends the user/server identifiers, with the possible addition of the profile of the activated user (if changed).

In such way, the new functionality provided by the proposed solution is completely opaque to the user. In particular, such technique is implemented without requiring any modification to the messaging agents 405a already existing.

The same operations described above can also be performed by the messaging server 110m. In such case, the repositories 415,420 also store the profile of each registered/active user. A similar updating agent 437 retrieves the search parameters of the web sites included in the profile of the activated user (action A3′), and replaces them in such profile in the repositories 415,420 (action A4′). The messaging manager 410 extracts the profile of the user (if necessary) from the repository 420 (action A5′). The same messaging manager 410 can then notify the event to the searching server 110r, by sending the user/server identifiers with the possible addition of the new profile of the activated user (action A6′).

Moving now to the searching server 110r, the notification of the new activated users in the different messaging services available in the system are all received from a user manager 440. In response thereto, the user manager 440 adds each new active user to a correspondent repository 445 (action A7). In an alternative embodiment of the invention, the clients 115a and/or the messaging servers 110m can send—to the searching server 110r—the profile the activated user as defined (that is, with the indication of the possible web sites). In such case, a spider (or crawler) 447 is periodically activated (for example, every 1-5 days); the spider 447 analyzes the entire web in order to find the search parameters of all the web sites (action A8). Such information (saved on the searching server 110r) is used to replace any web site included in the profile of the activated user with the corresponding search parameters, at the moment of his/her insertion in the repository 445 (action A9).

A generic requesting user uses a different client (denoted with 115b); the requesting user of the client 115b activates a browser to surf in the Internet, and in particular to access the searching server 110r. In such way, the requesting user can query the searching server 110r for the desired active users, by submitting a corresponding search criterion (action A10). The request is received by a search engine 455. In an embodiment of the invention, the search engine 455 directly selects the active users 445 who satisfy the desired search criterion (action A11). Alternatively, the search engine 455 selects the web sites that satisfy the same search criterion (action A11a′); the search engine 455 then associates—to each selected web site—the possible active users 445 who include such web sites in their profiles (action A11b′). In both cases, the search engine 455 returns the result of the operation to the browser 450 (A12 action).

The requesting user can decide to contact one of the selected users. In such case, there is invoked a similar messaging agent 405b, which sends a desired message to the corresponding messaging manager 410; the messaging manager 410 in turn transmits the contact request to the messaging agent 405a of the desired user, assumed to be operating on the same client 115a as above for the sake of simplicity of description (action A13). Such event is intercepted by the plug-in module 425 on the client 115a (action A13′).

If the contacted user wishes to respond, a corresponding message is sent from the messaging agent 405a to the messaging manager 410, which transmits it to the messaging agent 450b of the requesting user (action A14). Such event as well is intercepted by the plug-in module 425 on the client 115a (action A14′). In such way, the plug-in module 425 can determine the response time of the contacted user (with the response that is considered missing after the predetermined maximum time). The plug-in module 425 notifies such information to an analyzer 460 listening on the searching server 110r (action A15). The same operations described above can also be performed by the messaging server 110m; particularly, the messaging manager 410 determines in a similar way the response time (and the possible missing response), and notifies the same information to the analyzer 460 (action A15′).

In any case, the analyzer 460 calculates the new percentage of responses to the contact requests and the average response time of the contacted user; the responsiveness index of the contacted user is then modified accordingly in the repository of the active users 445 (action A16).

Similar considerations apply if the repository 445 also stores an indication of the state of each active user (for example, occupied, temporarily absent, on the telephone, in a meeting, traveling, and similar). The initial state of each active user is communicated to the searching server 110r at the moment of the notification of his/her activation (action A6 or A6′). As above, the messaging agent 405a notifies any change of state to the messaging manager 410 (action A1). In response thereto, the messaging manager 410 updates the state of the active user in the repository 420 (action A2). The request of changing the state is intercepted on the client 115a by the plug-in module 425 (action A1′). The plug-in module 425 notifies the event to the user manager 440 (action A6), by sending the new state of the active user. The same operations can also be performed by the messaging server 110m, with the messaging manager 410 that directly sends to the new state of the active user to the user manager 440 (action A6′). In any case, the user manager 440 updates the information relating to the active user accordingly in the repository 445 (action A7). The state of the active users can be used (in addition to the respective search profiles) in order to select the users who satisfy the desired search criteria (for example, by limiting the result only to the active users at the moment available).

A procedure similar to the one described above in order to activate the user in the messaging service is used for his/her deactivation. In particular, the messaging agent 405a notifies the messaging manager 410 to this end (action A1). In response thereto, the messaging manager 410 removes the user from the repository 420 of the ones being active in the messaging service (action A2). The request of the user to deactivate himself/herself from the messaging service is intercepted on the client 115a by the plug-in module 425 (action A1′). The plug-in module 425 notifies the event to the user manager 440 (action A6), by sending the respective user/server identifiers. As above, the same operations can also be performed by the messaging server 110m, with the messaging manager 410 that directly sends the user/server identifiers of the deactivated user to the user manager 440 (action A6′). In any case, the user manager 440 removes the information relating to the deactivated user from the repository 445 (action A7). It should be noted that, when the profiles of the activated users are sent to the searching server 110r only if modified, the information of the deactivated user must be maintained on the searching server 110r (for example, by simply invalidating a corresponding entry in the repository 445 or moving it to a further repository); this allows restoring the profile of the user at a next activation thereof, if such profile is not sent by the client 115a or the messaging server 110m (because it is unchanged since the previous activation).

Naturally, in order to satisfy local and specific requirements, a person skilled in the art may apply to the embodiments of the solution described above many logical and/or physical modifications and alterations. Particularly, although the present invention has been described with a certain degree of particularity with reference to embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a matter of general design choice.

For example, similar considerations apply if the system has a different architecture or includes equivalent units. Moreover, each computer may have another structure or may include similar elements (such as cache memories temporarily storing the programs or parts thereof to reduce the accesses to the mass memory during execution); in any case, it is possible to replace the computer with any code execution entity (such as a PDA, a mobile phone, and the like).

It is emphasized that the term user as exploited in the present description does not have to be interpreted exclusively in the sense of a person. For example, the user can be an alias that refers to more persons; a typical application is that of an organization having a generic user (associated with a set of operators), which can be contacted virtually in real time—with the messages that are then automatically distributed to an actual operator available at the moment. Moreover, each user can define different policies relating to the publication of its availability—for example, indiscriminately for everybody, only for users being correlated according to a predefined number of depth levels (such as friends of friends), only for specific categories of users, and the like.

Although in the previous description reference has been made to a specific messaging service, that is not to be interpreted as a limitation; indeed, the same solution can also be used in similar applications, such as real-time chats, and the like. It is also evident that the described messages are merely exemplificative, and they may be replaced with any information, such as voice (for example, Voice Over IP or VoIP), static or moving images, attached files, and the like. Similar considerations apply if the users activate in the messaging services in a different way (even without any authentication), or if the event is notified to the searching server by sending different and/or further information (such as a telephone number of the users). For example, the concepts of the present invention may also be applicable to a mobile telephone service, in which the activation of each user is notified to the searching server when the mobile telephone is switched on (by the same mobile telephone or by the server of the mobile telephone manager).

Moreover, any other equivalent structure can be used on the searching server to store the active users. Likewise, the searching server may be queried with any other search criterion, and the result of the search can be notified to the requesting user by sending different and/or further information (such as the above-mentioned telephone number of the selected users). Similar considerations apply if the search engine is replaced with a distributed infrastructure (for example, based on Distributed Hash Table P2P algorithms or other architectures).

In any case, the requesting user can contact one or more of the selected users in any other way. In particular, there is not excluded the possibility of contacting a selected user directly from the requesting user, even without passing through the corresponding messaging server (for example, by telephone). Moreover, it is also possible to save the requests received by each contacted user in a stack (so as allow him/her to respond to some requests later on).

Of course, the activation of the user in the messaging service may be intercepted on the respective client with equivalent techniques (for example, by using an extension of the messaging agent). Moreover, in a different embodiment of the invention the same result may be obtained by using a dedicated messaging agent (which is in charge of managing the communications with both the searching server and the different messaging servers, in a way that is completely opaque to the user).

Similar considerations apply if the profile of the users is defined in a different way (for example, by using other formalisms).

It is evident that the feature of sending the profile of the activated user to the searching server when such profile has been changed is not strictly necessary; indeed, it is possible to send the profile in any case (with an increase of the traffic on the communication network but with a reduction of the memory use on the searching server for maintaining the profiles of all the users even when they are not active).

The above-described search parameters are merely indicative, and they should not be interpreted in a limitative manner; in any case, it is also possible to provide search parameters only based on the characteristics of the user and/or of the client.

The information relating to the semantic categories may also be used in a different way (for example, to group the selected users into homogenous sets—possibly adapted to be expanded in a tree structure); however, it is evident that such feature is not strictly necessary, and it may be omitted in a simplified embodiment of the invention.

The web sites included in the search profile may be identified in a different way (for example, through simple keywords). However, it should be understood that a simplified implementation without such feature is within the scope of the invention.

Similar considerations apply if the operation of replacing the web sites with the respective search parameters in the profile is performed in other way or with a different timing.

Alternatively, any other score may be used to define the responsiveness index of the active users (for example, defined by quality indicators calculated according to evaluations returned by the requesting users).

Without departing from the principles of the invention, it is possible to use the responsiveness index only to order the selected users (without providing such information to the requesting user).

Alternatively, the threshold value for discarding the selected users according to their responsiveness index may be defined in a dynamic way (for example, provided by the requesting user or variable per categories of queries). However, nothing prevents always returning all the selected users (irrespectively of their responsiveness index).

As above, it is evident that a simplified implementation without any responsiveness index of the active users is within the scope of the invention.

Naturally, the possible states of the active users mentioned above are not comprehensive.

Moreover, such information may simply be returned to the requesting users for its display (without limiting the outcome of the search); in any case, a simplified implementation of the invention that does not support the management of the states of the active users is contemplated.

Similar considerations apply to the process of deactivating the users in the messaging services; for example, when the profiles of the users are always sent to the searching server at their activation, it is possible to delete all the information of each deactivated user from the searching server.

Similar considerations apply if the program (which may be used to implement each embodiment of the invention) is structured in a different way, or if additional modules or functions are provided; likewise, the memory structures may be of other types, or may be replaced with equivalent entities (not necessarily consisting of physical storage media). In any case, the proposed solution lends itself to be implemented with an equivalent method (having similar or additional steps, even in a different order). In any case, the program may take any form suitable to be used by or in connection with any data processing system, such as external or resident software, firmware, or microcode (either in object code or in source code). Moreover, it is possible to provide the program on any computer-usable medium. Examples of such medium are fixed disks (where the program can be pre-loaded), removable disks, tapes, cards, wires, fibers, wireless connections, networks, broadcast waves, and the like; for example, the medium may be of the electronic, magnetic, optical, electromagnetic, infrared, or semiconductor type.

In any case, one or more embodiments of the solution according to the present invention lend themselves to be implemented with a hardware structure (for example, integrated in a chip of semiconductor material), or with a combination of software and hardware.

What is claimed is:

1. A method for searching users in a distributed data processing system including a plurality of messaging servers each one for providing a corresponding messaging service and a plurality of clients each one for exploiting at least one of the messaging services, wherein the method includes the steps of:
activating each one of a set of users through a corresponding client in a messaging service on the corresponding messaging server,
notifying an indication of the activated user to a searching server by the corresponding client or messaging server,
adding the activated user to a searching structure indicative of all the users being active in the system,
querying the searching server by a further user through a corresponding further client according to a search criterion,
selecting the active users in the searching structure that satisfy the search criterion,
returning an indication of the selected users from the searching server to the further client, and
contacting at least one of the selected users by the further user.

2. The method according to claim 1, wherein the step of contacting at least one of the selected users by the further user includes:
sending a contact request from the further client to the client of the at least one selected user through the corresponding messaging server.

3. The method according to claim 1, wherein the step of notifying the indication of the activated user to the searching server includes:
intercepting the activation of the user in the messaging service on the client, and
sending the indication of the activated user to the searching server by the client.

4. The method according to claim 1, wherein a search profile is associated with each user, the step of selecting including:
determining the selected users according to a comparison between the search criterion and the search profiles of the active users.

5. The method according to claim 4, wherein the step of notifying the indication of the activated user to the searching server includes:
verifying a change of the search profile since a last execution of the step of notifying, and
sending the search profile in response to the change.

6. The method according to claim 4, wherein the search profile includes a set of search parameters indicative of characteristics of the user and/or of the corresponding client.

7. The method according to claim 6, wherein at least one of the search parameters is associated with a semantic category, the step of selecting including:
determining the selected users further according to a comparison between the search criterion and the semantic category of at least one of the search parameters of the active users.

8. The method according to claim 4, wherein the search profile includes an indication of at least one site of the system, each site being indexed through a further set of search parameters, and wherein for each site included in the search profile the method further includes the steps of:
retrieving the further search parameters of the site, and
replacing the indication of the site with the further search parameters in the search profile.

9. The method according to claim 8, wherein the steps of retrieving the further search parameters of the site and replacing the indication of the site with the further search parameters in the search profile are executed under the control of the client or the messaging server before the step of notifying the indication of the activated user to the searching server.

10. The method according to claim 8, wherein the steps of retrieving the further search parameters of the site and replacing the indication of the site with the further search parameters in the search profile are executed under the control of the searching server.

11. The method according to claim 10, wherein the steps of retrieving the further search parameters of the site and replacing the indication of the site with the further search parameters in the search profile are executed periodically for all the active users in the searching structure.

12. The method according to claim 8, wherein the step of selecting includes:
selecting the sites of the system that satisfy the search criterion, and
associating, with each selected site, the active users in the search structure whose search profile includes the selected site, and
wherein the step of returning the indication of the selected users includes:
sending an indication of the selected sites together with the associated active users.

13. The method according to claim 1, further including the steps of:
determining a responsiveness index of each selected user according to a response of the selected user to each contact.

14. The method according to claim 13, wherein the step of determining the responsiveness index of each selected user includes:
returning an indication of a response time of the selected user to each contact by the corresponding client or messaging server to the searching server, and
calculating the responsiveness index by the searching server according to the response times of the selected user.

15. The method according to claim 13, wherein the step of selecting includes:
ordering the selected users according to the corresponding responsiveness indexes.

16. The method according to claim 13, wherein the step of returning the indication of the selected users includes:
sending an indication of the responsiveness index of each selected user.

17. The method according to claim 13, wherein the step of selecting includes:
discarding the selected users according to a comparison of the corresponding responsiveness indexes with a threshold value.

18. The method according to claim 1, wherein the searching structure further includes an indication of a state of each active user, the method further including the steps of:
notifying a variation of state of each varied one of the active users to the searching server by the corresponding client or messaging server, and
updating the state of the varied active user in the searching structure.

19. The method according to claim 18, wherein the step of selecting includes:
determining the selected users further according to a comparison between the search criterion and the state of the active users.

20. The method according to claim 1, further including the steps of:
deactivating each one of the users through the corresponding client in the messaging service on the corresponding messaging server,
notifying an indication of the deactivated user to the searching server by the corresponding client or messaging server, and
removing the deactivated user from the searching structure.

21. A computer program product including a computer-usable medium embodying a computer program, the computer program when executed on a distributed data processing system, including a plurality of messaging servers each one for providing a corresponding messaging service and a plurality of clients each one for exploiting at least one of the messaging services, causing the system to perform a method for searching users in the system, wherein the method includes the steps of:
activating each one of a set of users through a corresponding client in a messaging service on the corresponding messaging server,
notifying an indication of the activated user to a searching server by the corresponding client or messaging server,
adding the activated user to a searching structure indicative of all the users being active in the system,
querying the searching server by a further user through a corresponding further client according to a search criterion,
selecting the active users in the searching structure that satisfy the search criterion,
returning an indication of the selected users from the searching server to the further client, and
contacting at least one of the selected users by the further user.

22. A system for searching users in a distributed data processing system including a plurality of messaging servers each one for providing a corresponding messaging service and a plurality of clients each one for exploiting at least one of the messaging services, wherein the system includes:
means for activating each one of a set of users through a corresponding client in a messaging service on the corresponding messaging server,
means for notifying an indication of the activated user to a searching server by the corresponding client or messaging server,
means for adding the activated user to a searching structure indicative of all the users being active in the system,
means for querying the searching server by a further user through a corresponding further client according to a search criterion,
means for selecting the active users in the searching structure that satisfy the search criterion,
means for returning an indication of the selected users from the searching server to the further client, and
means for contacting at least one of the selected users by the further user.

23. A distributed data processing system for searching users, the system including a plurality of messaging servers each one for providing a corresponding messaging service, a plurality of clients each one for exploiting at least one of the messaging services, and at least one searching server, wherein:
each client includes means for activating a corresponding user in a messaging service on the corresponding messaging server and means for notifying an indication of the activated user to the searching server,
each searching server includes means for adding the activated user to a searching structure indicative of all the users being active in the system,
each client further includes means for querying the searching server by a further user according to a search criterion,
each searching server further includes means for selecting the active users in the searching structure that satisfy the search criterion, and means for returning an indication of the selected users from the searching server to the client of each further user, and
each client still further includes means for contacting at least one of the selected users by the further user.

24. A distributed data processing system for searching users, the system including a plurality of messaging servers each one for providing a corresponding messaging service, a plurality of clients each one for exploiting at least one of the messaging services, and at least one searching server, wherein:
each client includes a messaging agent for activating a corresponding user in a messaging service on the corresponding messaging server and a plug-in module for notifying an indication of the activated user to the searching server,
each searching server includes a user manager for adding the activated user to a searching structure indicative of all the users being active in the system,
each client further includes a browser for querying the searching server by a further user according to a search criterion,
each searching server further includes a search engine for selecting the active users in the searching structure that satisfy the search criterion, and for returning an indication of the selected users from the searching server to the client of each further user, and
the messaging agent of each client is further adapted to contact at least one of the selected users by the further user.

25. A distributed data processing system for searching users, the system including a plurality of messaging servers each one for providing a corresponding messaging service, a plurality of clients each one for exploiting at least one of the messaging services, and at least one searching server, wherein:
each client includes means for activating a corresponding user in a messaging service on the corresponding messaging server,
each messaging server includes means for notifying an indication of the activated user to the searching server,
each searching server includes means for adding the activated user to a searching structure indicative of all the users being active in the system,
each client further includes means for querying the searching server by a further user according to a search criterion,
each searching server further includes means for selecting the active users in the searching structure that satisfy the search criterion, and means for returning an indication of the selected users from the searching server to the client of each further user, and
each client still further includes means for contacting at least one of the selected users by the further user.

26. A distributed data processing system for searching users, the system including a plurality of messaging servers each one for providing a corresponding messaging service, a plurality of clients each one for exploiting at least one of the messaging services, and at least one searching server, wherein:
each client includes a messaging agent for activating a corresponding user in a messaging service on the corresponding messaging server,
each messaging server includes a messaging manager for notifying an indication of the activated user to the searching server,
each searching server includes a user manager for adding the activated user to a searching structure indicative of all the users being active in the system,
each client further includes a browser for querying the searching server by a further user according to a search criterion,
each searching server further includes a search engine for selecting the active users in the searching structure that satisfy the search criterion, and for returning an indication of the selected users from the searching server to the client of each further user, and
the messaging agent of each client is further adapted to contact at least one of the selected users by the further user.
